(19) United States
(12) Patent Application Publication
(10) Pub. No.: US 2024/0141659 A1
(43) Pub. Date: May 2, 2024

(54) SYSTEM AND METHOD FOR AUTOMATICALLY MOUNTING BRACKETS WITHIN A BUILDING SITE

(71) Applicant: Raise Robotics, Inc., San Francisco, CA (US)

(72) Inventors: Jiayi Chen, San Francisco, CA (US); Conley Oster, Bath, PA (US)

(21) Appl. No.: 18/384,260

(22) Filed: Oct. 26, 2023

Related U.S. Application Data
(63) Continuation of application No. 63/455,844, filed on Mar. 30, 2023.
(60) Provisional application No. 63/419,566, filed on Oct. 26, 2022.

(51) Int. Cl. E04G 21/16; B25J 11/00

(52) U.S. Cl. CPC E04G 21/16; B25J 11/005

(57) ABSTRACT

A method for installing brackets includes: triggering a robotic arm to retrieve a fastener; and scanning a first image captured by a camera defining a view of a location of a bracket for features of a strut channel. The method also includes, in response to detecting features of the strut channel: maneuvering the end effector to locate the fastener over the strut channel based on the strut channel pose; and driving the end effector to couple the fastener within the strut channel. The method further includes: triggering the end effector to retrieve the bracket; and scanning a second image captured at the optical sensor for features of the fastener. The method also includes, in response to detecting features of the fastener: maneuvering the end effector to locate the bracket over the fastener based on the fastener pose; and driving the end effector to couple the bracket to the fastener.

### CROSS-REFERENCE TO RELATED APPLICATIONS

This application also claims the benefit of U.S. Provisional Application No. 63/419,566, filed on 26 Oct. 2022, which is hereby incorporated in its entirety by this reference.

### TECHNICAL FIELD

This invention relates generally to the field of construction processes and more specifically to a new and useful method for automatically mounting brackets within building sites in the field of construction processes.

### BRIEF DESCRIPTION OF THE FIGURES

FIG. 1 is a flowchart representation of a method;

FIG. 2 is a flowchart representation of a method;

FIG. 3 is a flowchart representation of a method;

FIG. 4 is a flowchart representation of a method;

FIGS. 5A and 5B are flowchart representations of a method; and

FIG. 6 is a flowchart representation of a method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

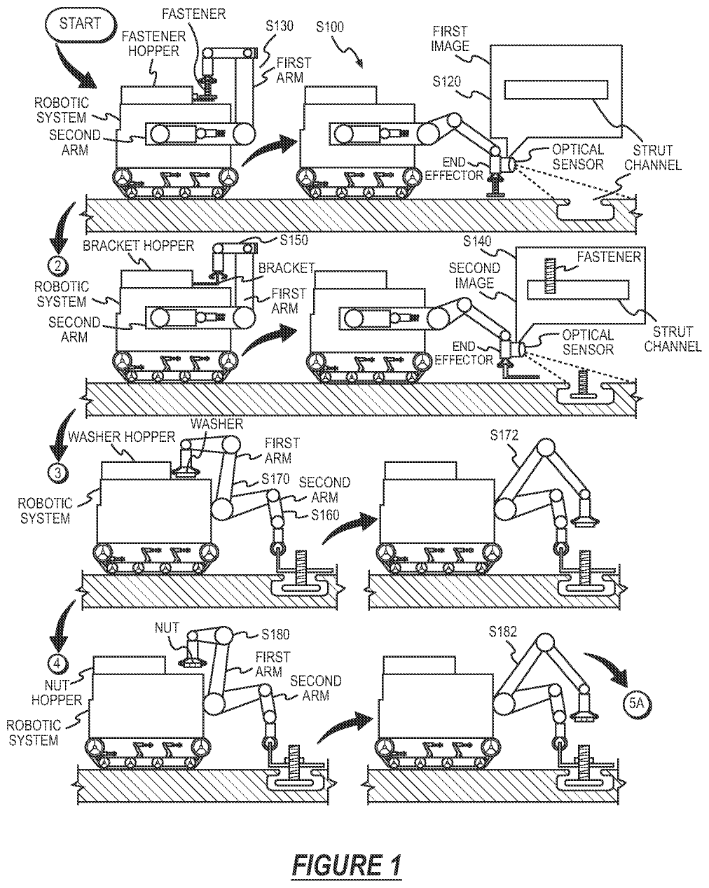

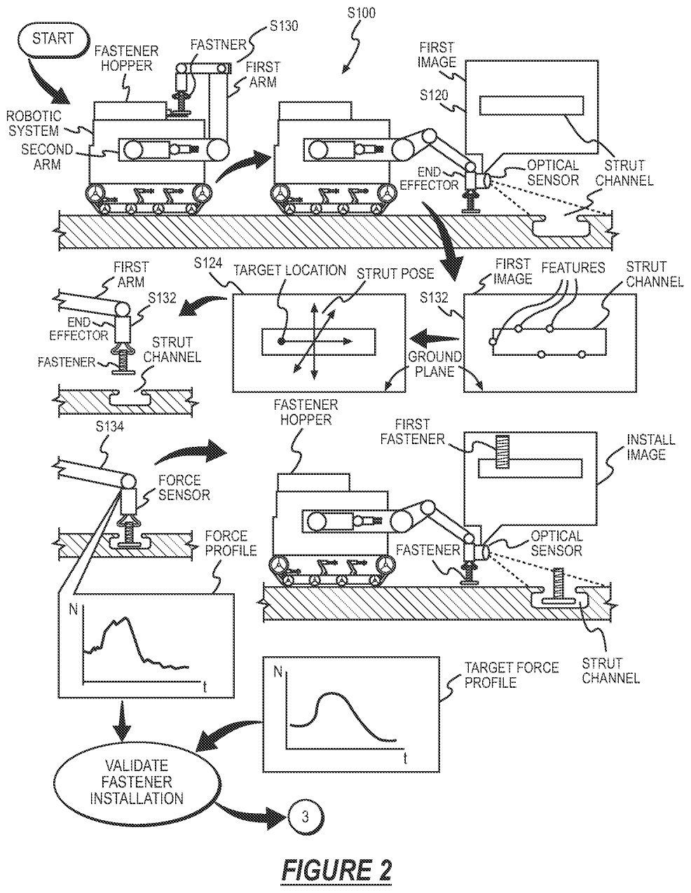

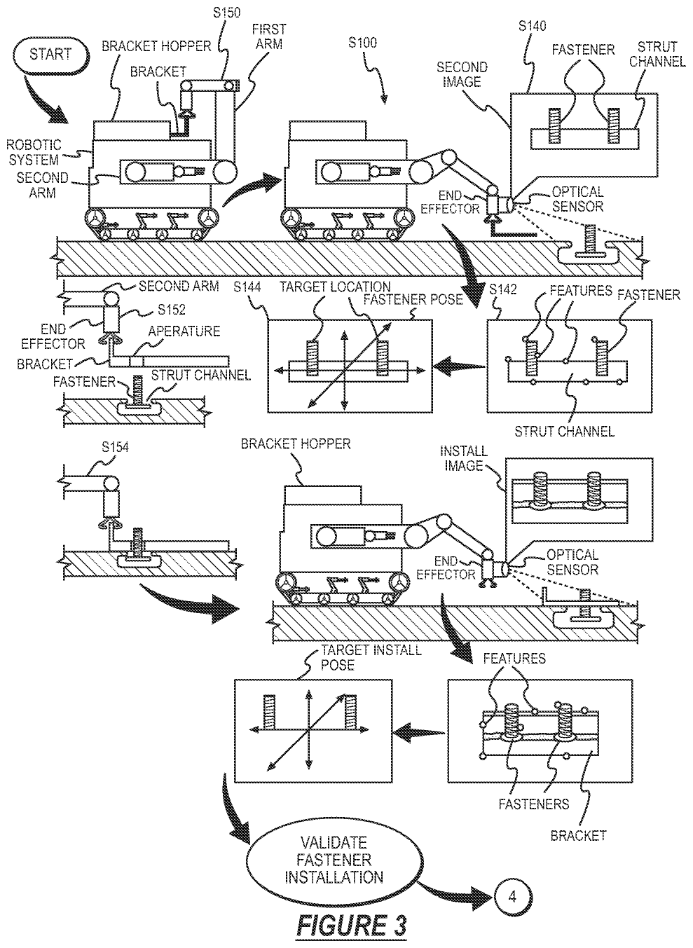

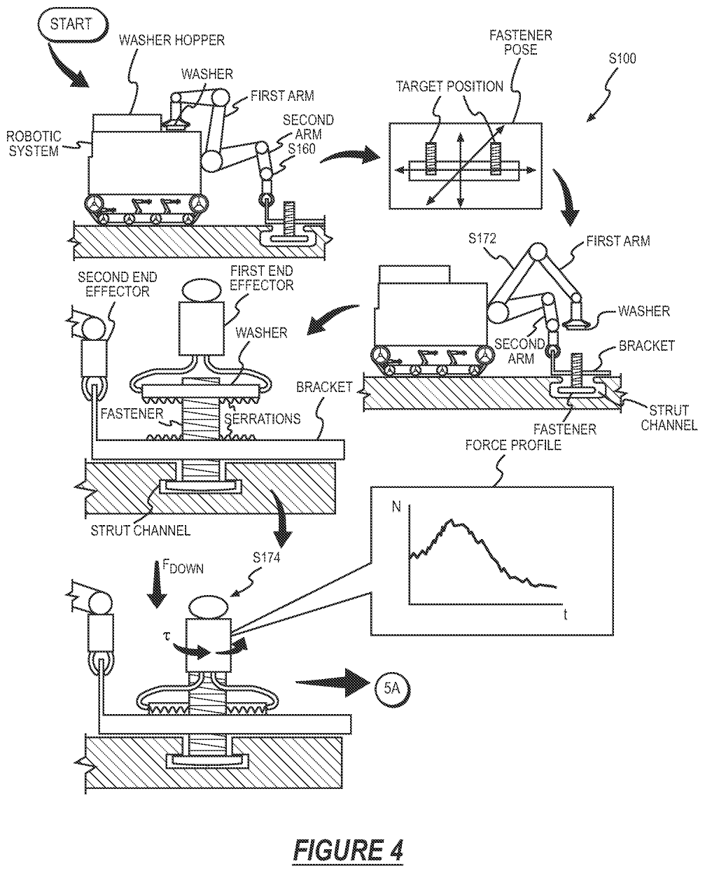

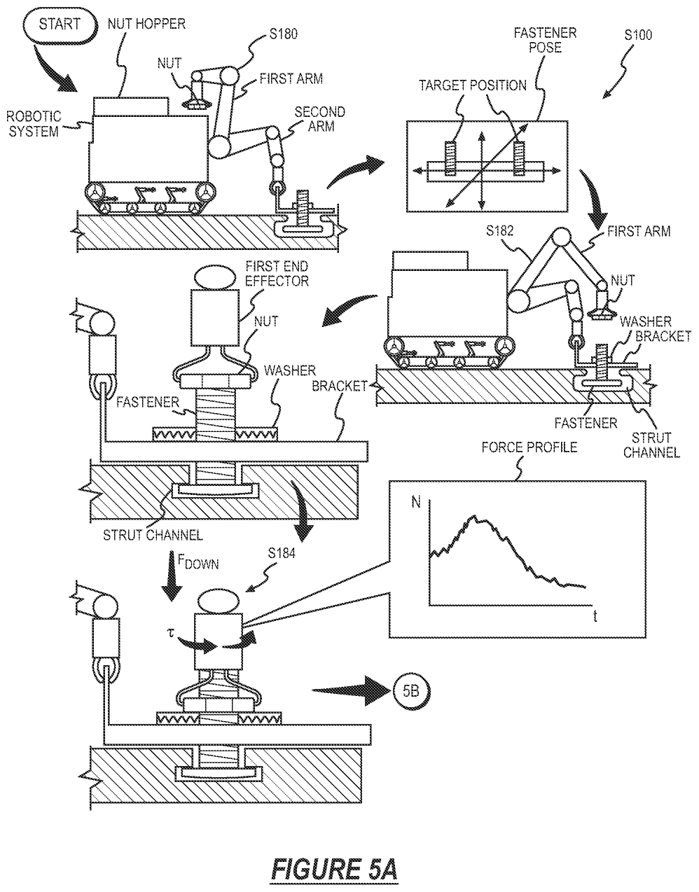

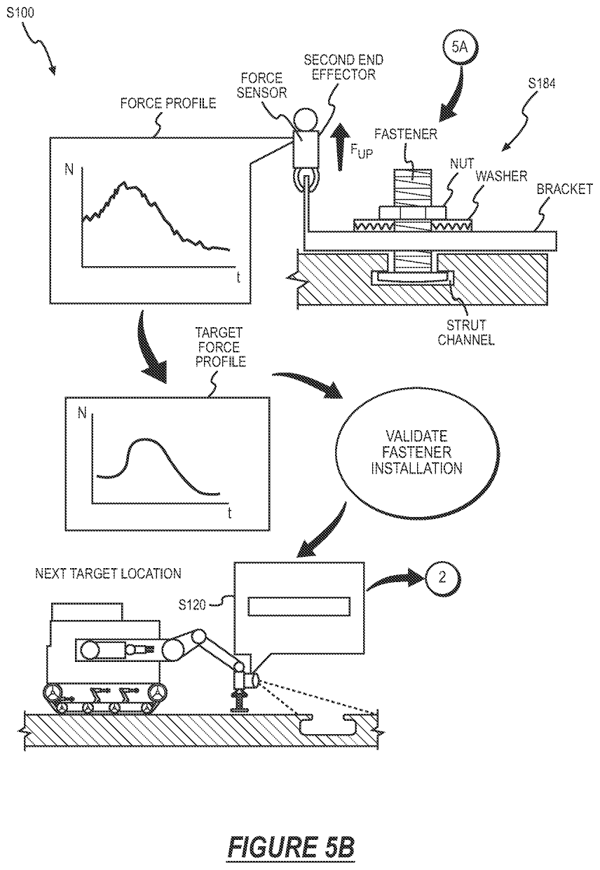

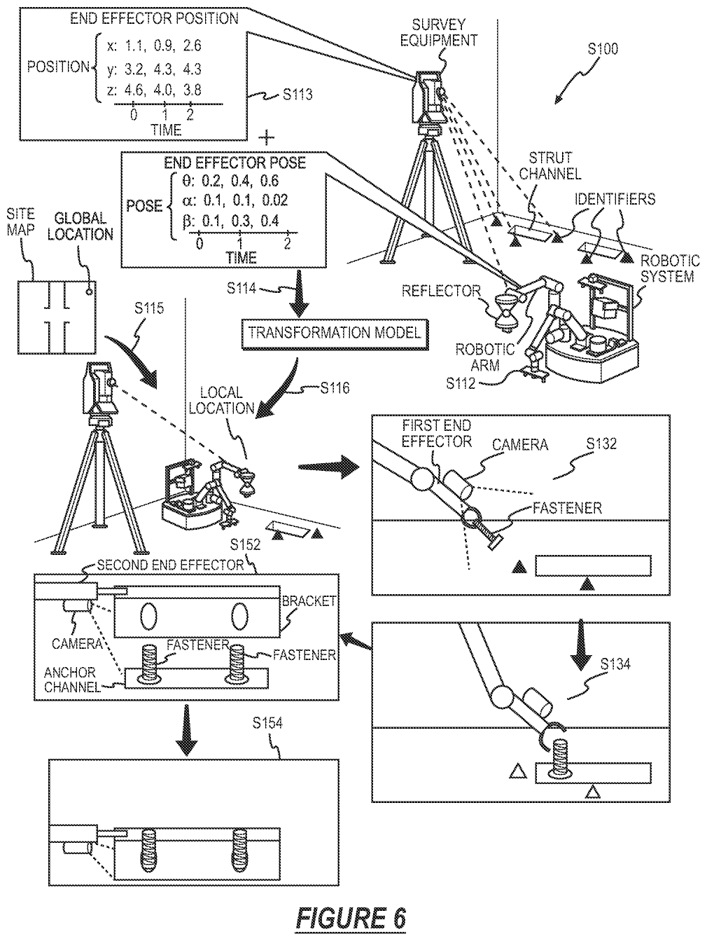

As shown in FIG. 1, a method S100 for autonomously installing facade brackets within a building site includes: at a first time, accessing a first image from an optical sensor in Block S120, arranged at a robotic system proximal a fenestration at the building site and defining a field of view of a local location of a facade bracket of the fenestration; extracting a first set of visual features from a first region in the first image bounding a strut channel at the local location of the facade bracket in Block S122; and interpreting a strut channel pose of the strut channel based on the first set of visual features from the first image in Block S124.

The method S100 further includes, in response to the strut channel pose corresponding to a target channel pose: triggering a first robotic arm at the robotic system to maneuver a first end effector, coupled to the first robotic arm, proximal a fastener hopper arranged at the robotic system; triggering the first end effector to retrieve a first fastener from the fastener hopper in Block S130; maneuvering the first end effector to locate the first fastener over the strut channel based on the strut channel pose in Block S132; and driving the first end effector toward the strut channel to locate the first fastener at a first lateral position along the strut channel in Block S134.

The method S100 also includes: at a second time following the first time, accessing a second image from the optical sensor in Block S40, defining the field of view of the local location of the facade bracket; extracting a second set of visual features from a second region in the second image bounding the first fastener arranged within the strut channel in Block S142; and interpreting a fastener pose of the first fastener based on the second set of visual features from the second image in Block S144.

The method S100 further includes, in response to the fastener pose corresponding to a target fastener pose: triggering a second robotic arm at the robotic system to maneuver a second end effector, coupled to the second robotic arm, proximal a bracket hopper arranged at the robotic system; triggering the second end effector to retrieve a facade bracket from the bracket hopper in Block S150; maneuvering the second end effector to locate a first aperture of the facade bracket over the first fastener at the strut channel based on the fastener pose in Block S152; and driving the second end effector toward the strut channel to couple the facade bracket to the first fastener at the strut channel in Block S154.

### 1.1 Method: Localization+Installation

As shown in FIG. 1, a method S100 for autonomously installing facade brackets within a building site includes, during a first time period at a robotic system, sweeping a first end effector on a first robotic arm through a first sequence of poses defined within a robotic coordinate system in Block S112.

The method S100 further includes accessing a first sequence of reference positions of the first end effector, within a reference coordinate system and derived from carrier signals reflected from a first reflector on the first robotic arm, from a survey sensor arranged in the building site in Block S113.

The method S100 also includes deriving a first transformation model between poses of the first end effector and a building coordinate system, defined in a site map for describing the building site in Block S114, based on: the first sequence of poses; the first sequence of reference positions; and a position of the survey sensor within the building site.

Additionally, the method S100 includes: extracting a target global location of a facade bracket of a fenestration proximal the robotic system, in the building coordinate system, from the site map in Block S115; and transforming the target global location of the facade bracket in the building coordinate system into a local location of the facade bracket in the robotic coordinate system based on the first transformation model in Block S116.

Furthermore, the method S100 includes: accessing a first image captured by a camera arranged on the robotic system and defining a field of view intersecting the local location of the facade bracket in Block S120; and scanning a first region of the first image for features of a strut channel, the first region bounding the local location of the facade bracket in Block S122.

The method S100 also includes, in response to detecting features of the strut channel within the first region of the image: deriving a pose of the strut channel from the features scanned in the first region of the first image in Block S124; triggering the first robotic arm to maneuver the first end effector proximal a fastener hopper at the robotic system; triggering the first end effector to retrieve the first fastener from the fastener hopper in Block S130; and sweeping the first end effector through a first path to locate the first fastener over the strut channel based on the pose of the strut channel in Block S132. Additionally, the method S100 includes: driving the first end effector toward the strut channel to locate the first fastener within the strut channel; driving the first end effector to rotate the first fastener within the strut channel; and driving the first end effector to locate the first fastener within a target lateral position within the strut channel based on the location of the facade bracket in Block S134.

Furthermore, the method S100 includes: accessing a second image captured by the camera arranged on the robotic system and defining a field of view intersecting the local location of the facade bracket including the first fastener within the strut channel in Block S140; and scanning a second region of the second image for features of the first fastener in Block S142.

The method S100 further includes: deriving a pose of the first fastener at the strut channel from the features scanned from the second region of the second image in Block S144; triggering a second robotic arm to maneuver a second end effector proximal a bracket hopper; triggering the second end effector to retrieve a first bracket from the bracket hopper in Block S150; sweeping the second end effector through a second path to locate the first bracket over the first fastener at the strut channel based on the pose of the first fastener in Block S152; and driving the second end effector toward the strut channel to locate the first bracket over the first fastener in Block S154.

### 2. Applications

Generally, blocks of the method S100 can be executed by a robotic system located within a building site in order to autonomously mount facade brackets at fenestration locations arranged about the building site. In particular, the robotic system can: cooperate with a survey sensor arranged within the building site to autonomously localize the robotic system at a target global location within a building coordinate system proximal a fenestration of the building site; and subsequently execute a component installation cycle to mount fasteners, glazing brackets, washers, nuts, etc. at the fenestration of the building site.

The robotic system can include: a drive chassis configured to drive a set of wheels (e.g., castor wheels, threads) coupled to the drive chassis; a first end effector arranged at the drive chassis; a first hopper arranged at the drive chassis and configured to dispense a first fastener; a second end effector arranged at the drive chassis; and a second hopper arranged at the drive chassis and configured to dispense a first facade bracket. Additionally, the robotic system can include: a first camera arranged at the first end effector and defining a first field of view of a local location within the building site; a first reflector arranged at the first end effector and configured to reflect (or “bounce back”) carrier signals emitted from the survey sensor within the building site; a second camera arranged at the second end effector and defining a second field of view of the local location within the building site; and a second reflector arranged at the second end effector and configured to reflect (or “bounce back”) the carrier signals emitted from the survey sensor within the building site.

The robotic system can derive a transformation model in order to achieve localization of the first end effector and the second end effector within a target global location—defined in a site map for the building site—for mounting a facade bracket at a fenestration within the building site. In particular, the robotic system can: sweep the first end effector through a first sequence of reference poses defined within a robotic coordinate system; retrieve a first sequence of reference positions of the first end effector within a reference coordinate system and derived from carrier signals reflected from the first reflector at the first end effector; and interpret the transformation model between poses of the first end effector within the building coordinate system, defined in a site map (e.g., 3D map) based on the first sequence of poses, the first sequence of reference positions, and a position of the survey sensor within the building site.

For example, the robotic system can implement coordinate measurement techniques, such as trigonometry, triangulation in order to interpret the transformation model. Additionally, the robotic system can repeat these steps for each end effector at the robotic system in order to generate a transformation model enabling targeted mobility of the robotic system within the building coordinate system of the building site. Upon deriving the transformation model, the robotic system can then: extract a target global location within the building coordinate system of the building site, such as a target global location to locate a facade bracket proximal to a fenestration within the building site: and autonomously maneuver the robotic system to this target global location based on the derived transformation model in preparation for executing a component mounting cycle at the fenestration within the building site. Therefore, the robotic system can locate end effectors to a target location of a facade bracket within the building site without reliance computer vision techniques (e.g., edge detection, template matching).

Once the robotic system is maneuvered to a target global location for mounting a facade bracket at a fenestration within the building site, the robotic system can autonomously perform a component mounting cycle at the target global location in order to mount brackets, fasteners, washers, nuts at this target global location. In particular, the robotic system can: retrieve mounting components from hoppers at the robotic system; interpret a pre-installation pose of the first end effector based on extracted features from images captured from the first camera at the target global location; sweep the first end effector to this pre-installation pose; and execute installation cycles to mount the component at the target global location.

In one example, the robotic system can initially mount a first fastener within a strut channel located at the target global location for mounting a facade bracket. In this example, the robotic system can: maneuver a first robotic arm at the robotic system to locate a first end effector, coupled to the first robotic arm, proximal a first hopper at the robotic system; trigger the first end effector to retrieve the first fastener from the first hopper; access a first image captured from the first camera at the first end effector depicting a strut channel; and implement computer vision techniques (e.g., edge detection, ground plane construction) to interpret a target pre-installation pose of the first end effector relative the strut channel. The robotic system can then: sweep the first end effector to locate the first end effector—and therefore the first fastener—at the target pre-installation pose over the strut channel; and drive the first end effector toward the strut channel to couple the first fastener within the strut channel. In particular, the robotic system can: drive the first end effector to locate the first fastener within the strut channel; drive the first end effector to rotate the first fastener within the strut channel, thereby securing the first fastener within the strut channel; and drive the first end effector to locate the first fastener at a target lateral position about the strut channel. The robotic system can further repeat steps of this process to: couple a second fastener within the strut channel; and locate this second fastener at a second target lateral position about the strut channel relative the first fastener within the strut channel.

Additionally, the robotic system can subsequently couple a glazing bracket to the first fastener and the second fastener arranged at the strut channel. In this example, the robotic system can: trigger a second robotic arm at the robotic system to maneuver a second end effector, coupled to the second robotic arm, proximal a second hopper at the robotic system; trigger the second end effector to retrieve the bracket from the second hopper; access a second image captured at the second camera at the second end effector depicting the first fastener and second fastener arranged at the strut channel; and implement computer vision techniques (e.g., edge detection, ground plane construction) to interpret a target pre-installation pose of the second end effector relative the first fastener and the second fastener. The robotic system can then: sweep the second end effector to locate the glazing bracket in alignment with the first fastener and the second fastener at the strut channel; and drive the second end effector toward the first fastener and the second fastener in order to couple the first fastener at a first opening of the glazing bracket and couple the second fastener at a second opening of the glazing bracket.

The system can implement similar techniques as described above to couple washers and nuts to the fasteners arranged at the strut channel, thereby rigidly securing the glazing bracket at the strut channel. Thus, the system can repeat this process for each target global location defined in the site map for the building site in order to accurately and autonomously mount facade brackets for fenestrations within the building site.

### 3. Survey Sensor

Generally, the robotic system cooperates with a survey sensor (e.g., total station) within the building site in order to localize the robotic system at a target global location within the building site. Generally, the survey sensor can include: a station chassis; an optical sensor; a tri-pod mount; and a controller. The station chassis: includes an emitter (e.g., a solid-state emitter) configured to emit a carrier signal (e.g., a modulated infrared carrier signal); and is coupled to the tri-pod mount. The optical sensor: is arranged within the station chassis; and is configured to capture visual data (e.g., video feeds, images, infrared signals) within the building site. Generally, the controller is configured to: retrieve visual data captured by the optical sensor; and interpret offset distances of objects arranged proximal the survey sensor based on the visual data captured by the optical sensor.

### 4. Robotic System

In one implementation, the robotic system includes: a drive chassis; a first robotic arm; a first hopper; and a controller. The drive chassis: includes a drive system coupled to a set of wheels; and is configured to automatically maneuver the robotic system about the building site, such as in response to receiving a mounting instruction from an operator device associated with an operator and/or from a remote computer system. The first robotic arm: is coupled to the drive chassis; includes a first end effector coupled to a distal end of the first robotic arm; and includes a set of positional sensors (e.g., joint encoders) arranged at each joint of the first robotic arm. In this implementation, the first end effector: can define a first gripping tool configured to grasp fastening elements from the first hopper arranged on the drive chassis; and includes a first reflector configured to reflect carrier signals emitted from the survey sensor. The first hopper: is coupled to the drive chassis; and is configured to store a set of fasteners. Generally, the controller is configured to: trigger the drive system to automatically maneuver the robotic system proximal a target global location at the building site; and trigger a mounting instruction at the robotic system to couple a first fastener retrieved from the hopper by the first end effector to a strut channel at the target global location in the building site.

In the aforementioned implementation, the robotic system can further include: a second robotic arm; and a second hopper. The second robotic arm: is coupled to the drive chassis; includes a second end effector coupled to a distal end of the second robotic arm; and includes a second set of positional sensors (e.g., joint encoders) arranged at each joint of the second robotic arm. In this implementation, the second end effector: can define a second gripping tool configured to grasp glazing brackets from the second hopper; and includes a second reflector configured to reflect carrier signals emitted from the survey sensor. The second hopper: is coupled to the drive chassis; and is configured to store a set of glazing brackets.

In another implementation, the robotic system can include: a set of hoppers configured to contain a set of mounting elements; and a set of robotic arms configured to maneuver end effectors proximal the set of hoppers in order to retrieve mounting elements from the set of hoppers. For example, the set of hoppers can include: a bracket hopper containing a set of bracket elements and configured to successively dispense a bracket element in the set of bracket elements; a washer hopper containing a set of washer elements and configured to successively dispense a washer element in the set of washer elements; and a fastener hopper containing a set of fastener element and configured to successively dispense a fastener element in the set of fastener elements. In the aforementioned example, the set of robotic arms each include an end effector configured to grip a mounting element from the set of hoppers and/or an end effector configured to drive (e.g., drill, maneuver) the mounting elements at the target global location within the building site. Therefore, since the mounting elements are consistently dispensed from the set of hoppers in a target orientation, the robotic system can automatically retrieve mounting elements from the set of hoppers without relying on computer vision techniques to confirm presence/and or orientation of the mounting elements dispensed from the set of hoppers.

Furthermore, the robotic system can include a first camera: coupled to the robotic arm at the end effector; and defining a field of view of the end effector and the target global location in the building site. Additionally or alternatively, the robotic system can further include a second camera: arranged at the drive chassis of the robotic system; and configured to capture images of the robotic arm including the end effector. In this implementation, the robotic system can access images and/or video feeds from these additional optical sensors to improve positional resolution of the end effector and the robotic arm at the target global location within the building coordinate system of the building site during performance of the mounting instructions.

### 5. Building Site Localization

In one implementation, the survey sensor: is located within a building site (e.g., a construction site carrying out performance of a particular set of construction tasks); includes an optical sensor (e.g., infrared camera, color camera, etc.) coupled to the survey sensor; and is configured to interpret vertical angles, horizontal angles, and a slope distance to a particular point within the building site based on data obtained by the optical sensor. In this implementation, the survey sensor can: capture an image within the building site; detect a set of identifiers depicted in the image of the building site; and subsequently retrieve a site map, such as from an internal memory of the survey sensor and/or a remote computer system in communication with the survey sensor based on the set of identifiers depicted in the image.

For example, the survey sensor can: access a geospatial location of the survey sensor via an internal global positioning system (hereinafter “GPS”) coupled to the survey sensor; and identify a particular building site occupied by the survey sensor based on the geospatial location of the survey sensor. In this example, the survey sensor can then access a global site map (e.g., map containing floor plans, construction tasks, room locations) for the building site. In this example, the survey sensor is located at a particular space within the building site. The building site can include the set of identifiers (e.g., QR codes, fiducials) proximal the particular space occupied by the survey sensor: located at predetermined locations (e.g., walls, beams, ceilings) within a particular floor, and/or particular room within the building site; and corresponding to a particular site location within the site map for the building site. Therefore, the survey sensor can: capture an image of the particular space within the building site from the optical sensor coupled to the survey sensor; extract a set of visual features (e.g., corners, edges, areas gradients) from the image; detect the set of identifiers in the image of the particular space based on the extracted features from the image; and then query the site map for a particular site location corresponding to the set of identifiers within the particular space.

In the aforementioned example, the site map can include a set of target global locations, such as locations for mounting glazing brackets, deck ledger support brackets, post brackets, reinforcement brackets, etc. at the building site. Therefore, when the survey sensor is localized at the particular site location within the site map, the robotic system can: extract a particular set of target global locations for the particular site location at the building site; and subsequently automatically maneuver proximal these particular target global locations and trigger a mounting instruction at the robotic system in order to automatically couple brackets to strut channels at these target global locations.

In another implementation, an operator can manually confirm occupation of the survey sensor within the particular site location at the building site. For example, in response to identifying the particular site location of the survey sensor based on the set of identifiers, the survey sensor can: generate a prompt defining a selection for the particular site location at the building site and a total number of target global locations at the particular site location; and subsequently serve this prompt to the operator, such as via a display screen at the survey sensor and/or an external computer system associated with the operator. Upon receiving selection from the operator confirming the particular site location for the survey sensor, the robotic system can then: automatically maneuver proximal the target global locations within the building site; and trigger a mounting instruction in order to automatically couple brackets to strut channel at the target global locations.

### 5. Robotic System Localization

In one implementation, the survey sensor includes an emitter (e.g., a solid-state emitter) configured to emit a carrier signal (e.g., a modulated infrared carrier signal) directed toward the reflector at the end effector of the robotic system. The carrier signal is then reflected back to the survey sensor via the reflector and received at the optical sensor coupled to the survey sensor. The survey sensor can then execute scan cycles (e.g., 3 or more scan cycles) to: interpret an offset distance between the survey sensor and the robotic system based on this reflected carrier signals; interpret a pose of the robotic system based on the reflected carrier signals; store this offset distance and pose in the site map loaded at the survey sensor; and generate a prompt confirming presence of the robotic system at the particular location within the building site.

In this implementation, during a scan cycle, the survey sensor can: capture an image within the building site depicting a set of identifiers; extract a set of visual features in this image; identify the set of identifiers depicted in the image based on these extracted features; and locate the survey sensor at a particular site location in the site map based on the set of identifiers. Concurrently and/or subsequently, the survey sensor can then: trigger emission of a carrier signal toward the robotic system proximal the survey sensor and configured to reflect (or “bounce back”) at the reflector coupled to the end effector toward the optical sensor at the survey sensor; detect the reflected carrier signal at the optical sensor; and interpret an offset distance between the survey sensor and the robotic system based on the reflected carrier signal. The survey sensor can then execute a set of scan cycles (e.g., 3 or more scan cycles) to interpret the pose of the robotic system within the building site. Furthermore, the survey sensor can: represent the pose of the robotic system in the site map; and confirm presence of the robotic system at the particular site location within the building site based on the derived pose for the robotic system.

In another implementation, the robotic system can automatically maneuver the driver chassis at a target offset distance, such as stored in local memory at the survey sensor, retrieved from a remote computer system, and/or manually input by a user, to the survey sensor within the building site. In this implementation, the survey sensor can: interpret an offset distance between the survey sensor and the end effector based on the reflected carrier signal from the reflector at the end effector; and access a target offset distance between the survey sensor and the end effector. The survey sensor can then, in response to the interpreted offset distance deviating from the target offset distance, generate a maneuver instruction: defining an offset difference between the interpreted offset distance and the target offset distance; and configured to trigger the drive system at the robotic system to maneuver toward the target offset distance.

In the aforementioned implementation, the survey sensor and the robotic system can be communicably coupled by a wireless network protocol (e.g., 5G, WiFi, LTE) and/or communicably coupled to a remote computer system (e.g., a remote server). The survey sensor can then transmit the maneuver instruction directly to the robotic system and/or to the remote computer system in communication with the robotic system. The robotic system can subsequently execute the received maneuver instruction in order to automatically maneuver the robotic system to the target offset distance between the robotic system and the survey sensor.

### 6. End Effector Tracking

Blocks of the method S100 recite, during a first time period at a robotic system, sweeping a first end effector on a first robotic arm through a first sequence of poses defined within a robotic coordinate system in Block S112. The method S100 further recite accessing a first sequence of reference positions of the first end effector, within a reference coordinate system and derived from carrier signals reflected from a first reflector on the first robotic arm, from a survey sensor arranged in the building site in Block S113.

In one implementation, the robotic system can: sweep the first end effector on the first robotic arm through a first sequence of poses defined within a robotic coordinate system; access a set of reference positions of the end effector during the sweeping cycle for the robotic arm of the robotic system; and define a boundary (e.g., lines segment) for the end effector of the robotic arm relative the reference coordinate system based on these tracked positions of the end effector during the sweeping cycle.

For example, during a first segment in the sweeping cycle, the robotic system can: maneuver the end effector of the robotic system—and therefore the robotic arm—about an XY-plane relative the robotic coordinate system of the robotic system; reflect a set of carrier signals emitted from the survey sensor; retrieve the set of reflected carrier signals (i.e., reflected from the reflector at the end effector) from the survey sensor during motion of the end effector about the XY-plane; and interpret the set of positions for the end effector in about the XY-plane relative the building coordinate system based on the set of reflected carrier signals. In particular, the robotic system can implement coordinate measurement techniques, such as free stationing, trigonometry, and/or triangulation based on known positions of the survey sensor, the set of identifiers within the building site, and the end effector to interpret a set of positions (i.e., coordinate positions): representing motion of the end effector about the XY-plane relative the driver chassis and the survey sensor; and defining an first boundary (i.e., XY-plane boundary) of the end effector relative the building coordinate system. The robotic system can then: project this first boundary relative the building coordinate system; and subsequently track this boundary within the site map during motion of the robotic system about the building site.

The robotic system can then repeat the techniques described above during subsequent segments of the sweeping cycle in order to: interpret a set of reference positions representing motion of the end effector about additional geometric planes (e.g., XZ-plane, YZ-plane) relative the building coordinate system; and interpret additional geometric boundaries for the end effector at the robotic arm relative the building site for these additional geometric planes.

For example, the robotic system can, during a second segment in the sweeping cycle following the first segment: maneuver the end effector of the robotic system—and therefore the robotic arm—about the XZ-plane relative the robotic coordinate system of the robotic system; reflect a second set of carrier signals—at the reflector on the robotic system—emitted from the survey sensor; retrieve the second set of carrier signals (i.e., reflected from the reflector at the end effector) from the survey sensor during motion of the end effector about the XZ-plane; and interpret a second set of reference positions for the end effector in the XZ-plane relative the building coordinate system based on the second set of carrier signals. In particular, the robotic system can implement coordinate measurement techniques, as described above to interpret the second set of reference positions (i.e., coordinate positions): representing motion of the end effector about the XZ-plane relative the driver chassis and the survey sensor; and defining a second boundary (i.e., XZ-plane boundary) of the end effector relative the building coordinate system.

Therefore, the robotic system can: interpolate the first set of reference positions and the second set of positions derived for the end effector during the sweeping cycle; interpolate the first boundary and the second boundary of the end effector relative the drive chassis and the survey sensor within the building coordinate system of the building site; and interpret a transformation (e.g., translation, rotation) within the site map representing motion of the end effector about the building coordinate system of the building site.

### 6.1 Multiple Reflectors

In another implementation, the robotic system can include a set of reflectors (e.g., 3 reflector prisms): arranged at the end effector; and arranged about the robotic arm. The robotic system can then, during a single scan cycle: read a set of reflected carrier signals for each reflector arranged at the robotic system during motion of the end effector in the sweeping cycle; and interpret a set of positions for multiple points of the end effector and the robotic arm based on the set of reflected carrier signals received from each reflector at the robotic system, thereby increasing positional resolution of the end effector and the robotic arm during the sweeping cycle. The robotic system can then execute subsequent scan cycles to increase positional resolution of the robotic system within the building coordinate system.

### 6.2 Pose Tracking

In one implementation, the robotic system can: read a set of positional values (e.g., angular velocity) from a set of positional sensors coupled to the robotic arm during maneuvering of the end effector in the sweeping cycle; and, for each position, in the set of positions, interpret a pose for the end effector based on the positional values read from the positional sensors of the robotic arm. In this implementation, the robotic system can then: retrieve a kinematic model associated with the robotic system; insert the set of positional values retrieved from the set of positional sensors into the kinematic model for the robotic system; and subsequently interpret a sequence of poses for the end effector corresponding to the set of reference positions from the kinematic model. Additionally, the robotic system can then store the derived sequence of poses, for each position, in the set of positions within the site map.

In one example, the robotic system includes a robotic arm including: a set of six joints, each cooperating with the other to define motion in 6-degrees of freedom for the end effector coupled to the robotic arm; and a corresponding positional sensor for each joint, in the set of three joints, configured to measure a positional value of the joint. In this example, the system can trigger a sweeping cycle to maneuver the end effector through the sequence of poses about the XY-plane for the robotic coordinate system as described above. During the sweeping cycle, the robotic system can: read a set of positional values from each positional sensor, for the set of three joints, during maneuvering of the end effector; insert the set of positional values in the kinematic model for the robotic system; and interpret a pose, for each position, in the set of positions, based on the first set of positional values and the kinematic model.

Therefore, the robotic system can implement Blocks of the method S100 in order to: interpret a set of positions of the end effector relative the survey sensor and the drive chassis; and interpret a pose for the end effector at each position, in the set of positions, representing locations of the end effector within the building coordinate system of the building site without reliance on complex computer vision techniques.

### 7. Transformation Model+Target Global Location

Blocks of the method S100 recite deriving a first transformation model between poses of the first end effector and a building coordinate system, defined in a site map for describing the building site in Block S114, based on: the first sequence of poses; the first sequence of reference positions; and a position of the survey sensor within the building site. Additionally, the method S100 recite: extracting a target global location of a facade bracket of a fenestration proximal the robotic system, in the building coordinate system, from the site map in Block S115; and transforming the target global location of the facade bracket in the building coordinate system into a local location of the facade bracket in the robotic coordinate system based on the first transformation model in Block S116.

In one implementation, the robotic system can interpolate the set of reference points representing tracked locations of the end effector in the building coordinate system of the building site with the sequence of poses representing maneuvering of the end effector—and therefore the robotic arm—during the sweeping cycle in order to interpret a transformation model defining mobility of the end effector to a target global location within the building coordinate system of the building site. In this implementation, the transformation model defines maneuverability of the end effector to a set of target poses within the building coordinate system necessary for performance of mounting instructions that are proximal to target global locations within the building site for mounting glazing brackets. Thus, in this implementation, the robotic system can: extract a first target global location from the site map representing a location for designated mounting of a facade bracket of a fenestration in the building coordinate system; and transform the first target global location of the facade bracket in the building coordinate system into a local location of the facade bracket in the robotic coordinate system based on the transformation model.

In one example, the robotic system can: access a first reference position, in the set of reference positions, within the boundary associated with a first target pose; access a second reference position, in the set of reference positions, within the boundary associated with a second target pose, different from the first target pose; and calculate a first offset distance and direction between the first position and the second position based on known coordinate values for each of the first position and the second position. The system can then: repeat these steps for a third position and pose swept within the robotic coordinate system; and interpret the transformation model based on these three sampled points. Subsequently, the robotic system can repeat this process for multiple positions and poses swept within the boundary of the robotic coordinate system in order to interpret the transformation model representing maneuverability of the end effector within the building coordinate system of the building site.

Therefore, the robotic system can: interpret the transformation model based on recorded reference positions and sequence of poses of the end effector during a sweeping cycle; trigger the drive system of the robotic system to automatically maneuver the drive chassis proximal the target global location; and drive the end effector at a target pose relative the target global location in the building coordinate system based on the derived transformation model, thereby eliminating the need of complex computer vision techniques at the robotic system to localize the robotic system within the building coordinate system of the building site.

### 8. Component Installation

Generally, the robotic system can: maneuver the end effector of the robotic system to a target global location in the building coordinate system of the building site; interpret an installation location at the target global location based on captured images from a camera coupled to the end effector; trigger a robotic arm to locate the end effector proximal a hopper at the robotic system; trigger the end effector to retrieve the mounting component from the hopper; and sweep the end effector through a target path to locate the mounting component at the installation location. The robotic system can then drive the end effector toward the installation location in order to couple the mounting component at the installation location relative the target global location in the building site.

### 8.1 Collision Avoidance

In one implementation, the robotic system can: trigger the drive chassis to maneuver toward the target global location within the building site; and trigger the end effector to maneuver to a target pose at the target global location facing an installation location while simultaneously avoiding objects and collisions within the building site. In this implementation, the robotic system can include optical sensors (e.g., depth cameras, lidar cameras): arranged at the drive chassis of the robotic system; and defining a field of view for the robotic system relative the robotic coordinate system. The robotic system can then: access images and/or video feeds captured by the optical sensor during maneuvering of the robotic system to the target global location; extract features from these images and/or video feeds; detect objects within a field of view of the robotic system based on these extracted features; and interpret obstacles for the robotic system along a target pathway toward the target global location based on the detected objects.

Therefore, the system can calculate a target pathway toward a target global location in order to avoid obstacles and collision and thereby reduce exposure to risk for construction workers at the building site and/or other equipment units present at the building site.

### 8.2 Component Grasping

In one implementation, the robotic system can: maneuver a robotic arm to locate an end effector, coupled to the robotic arm, proximal a hopper at the robotic system; trigger the end effector to retrieve a mounting component from the hopper; and interpret a target pose for the mounting component upon retrieving the mounting component from the hopper.

In this implementation, the robotic system includes the hopper: mounted at a target orientation and a target position on the driver chassis; including a set of mounting components (e.g., brackets, fasteners, nuts, washers); and configured to dispense each mounting component, in the set of mounting components, in a target pose from the hopper. The robotic system further includes the end effector: defining a gripping tool (e.g., parallel gripper); and configured to retrieve (i.e., grip) a mounting component dispensed from the hopper at the target pose.

Thus, the robotic system can: execute installation cycles at the target global location in order to automatically retrieve a mounting component from the hopper; and interpret a pose for the mounting component, without reliance on computer vision, based on a mounting component type and a hopper type defining a target pose for dispensing the mounting component type.

### 8.3 Fastener Installation

Generally, the robotic system can execute a fastener installation cycle at the target global location in order to install a first fastener at a strut channel located proximal the fenestration in the building site. In particular, the robotic system can: detect a pose of the strut channel proximal the fenestration; interpret an installation location for the first fastener based on the pose of the strut channel; sweep the end effector—carrying the first fastener retrieved from the first hopper—to the installation location; and execute installation cycles to drive the first fastener toward the strut channel in order to couple the first fastener to the strut channel.

### 8.3.1 Strut Channel Detection

Blocks of the Method S100 recite: at a first time, accessing a first image from an optical sensor in Block S120, arranged at a robotic system proximal a fenestration at the building site and defining a field of view of a local location of a facade bracket of the fenestration; extracting a first set of visual features from a first region in the first image bounding a strut channel at the local location of the facade bracket in Block S122; and interpreting a strut channel pose of the strut channel based on the first set of visual features from the first image in Block S124.

In one implementation, the robotic system can: access a first image captured by a camera arranged at the first end effector of the robotic system defining a field of view intersecting the installation location of a glazing bracket at a fenestration within the building site; and scan a first region depicted in the first image for features of a strut channel. In this implementation, the robotic system can then: access a target channel pose, such as from an installation specification document stored in memory at the robotic system; interpret a strut channel pose at the local location based on the visual features extracted from the first region in the first image; and, in response to the strut channel pose corresponding to the target channel pose, initiating a fastener installation cycle in order to couple a fastener within the strut channel at the local location. More specifically, during the fastener installation cycle, the robotic system can implement closed loop controls to retrieve a fastener from a hopper at the robotic system and install the fastener at a target location within the strut channel.

In one example, the robotic system can: drive the end effector to a target offset between the end effector and the installation location facing the camera; trigger the camera to capture a first image depicting the installation location; project a bounding box defining the first region of the first image; and extract a set of visual features (e.g., edges, blobs, surfaces) from this first region of the first image. The robotic system can implement heuristic techniques for the first image, such as edge detection, ground plane detection, and/or surface reconstruction in order to detect presence of the strut channel in the first region of the first image. The robotic system can therefore initiate a component installation cycle for a glazing bracket at the target global location in response to detecting presence of the strut channel in the first image.

Alternatively, the robotic system can flag the fenestration for strut channel rework in response to detecting absence of the strut channel in the first image. For example, the robotic system can: detect absence of a strut channel in the first image based on the first set of features extracted from the first region of the first image; flag the fenestration for absence of a strut channel in the site map; generate a notification including the target global location of the fenestration in the site map and indicating absence of the strut channel; and subsequently serve this notification to a user, such as to a remote computer system and/or a mobile device associated with a supervisor of the building site.

In one implementation, the robotic system can: access an image from the optical sensor depicting a local location of the facade bracket at the fenestration; scan the image for visual features of a strut channel; and, based on the visual features, interpret a position of the strut channel across a building structure (e.g., wall, floor, ceiling) at the local location based on the visual features in the image. More specifically, the robotic system can: interpret the strut channel arranged across a ground plane (e.g., floor) of the building structure at the local location; and/or interpret the strut channel arranged across a perimeter plane (e.g., perimeter edge of the building structure), orthogonal the ground plane, of the building structure at the local location. In one example, the robotic system can: access the image from an optical sensor arranged at the first end effector of the robotic system and depicting the local location of the facade bracket; as described above, scan the image for visual features; and detect a fiducial across a ground plane of the building structure based on the visual features from the image indicating presence of a strut channel across the ground plane.

Accordingly, the robotic system can then: project a bounding box (e.g., rectangular window) in the image encompassing the fiducial—and therefore the strut channel—detected across the ground plane; and implement steps and techniques described below to extract visual features from the bounding box to interpret a strut channel pose of the strut channel across the ground plane.

In another example, the robotic system can: access a target global location of the facade bracket along a perimeter plane (i.e., orthogonal a ground plane) of the building structure from a site map; implement steps and techniques described above to transform the target global location of the facade bracket to a local location of the robotic system within the building site; and maneuver the robotic system proximal the local location, such as by maneuvering the robotic system adjacent a railing proximal the perimeter plane along the building structure. Accordingly, the robotic system can: maneuver a first end effector—including the optical sensor—to face the perimeter plane of the building structure corresponding to the local location of the facade bracket; capture an image by the optical sensor; and, as described above, detect a fiducial across the perimeter plane of the building structure based on visual features extracted from the image indicating presence of the strut channel across the perimeter plane.

Thus, the robotic system can implement steps and techniques described below to execute installation of a facade bracket at the local location across the perimeter plane of the building structure, thereby eliminating the need for an operator to manually install the facade bracket at the perimeter of the building structure.

### 8.3.2 Fastener Pre-Installation

In one implementation, the robotic system can: detect a particular pose for the strut channel based on the features extracted from the first region of the first image; interpret a pre-installation location for the first fastener at the strut channel based on the particular pose detected for the strut channel; and sweep the end effector—gripping the first fastener—along a pre-installation path to locate the end effector at the pre-installation location over the strut channel.

In one example, the robotic system can: interpret a strut channel coordinate system based on the particular pose detected for the strut channel; project the strut channel coordinate system over the strut channel relative the building coordinate system within the building site; and interpret the pre-installation location at the strut channel according to the strut channel coordinate system.

In particular the robotic system can: interpret a first axis (e.g., x-axis) for the strut channel according to a length of a strut channel opening defined in the particular pose; interpret a second axis (e.g., y-axis) for the strut channel perpendicular to the first axis according to a width of the strut channel opening defined in the particular pose; interpret a third axis (e.g., z-axis) for the strut channel normal to the first axis and the second axis representing a direction normal to a ground plane including the strut channel opening; and interpolate the first axis, the second axis, and the third axis to define the strut channel coordinate system for the strut channel.

The robotic system can then: project a target installation location in the strut channel coordinate system representing a pre-installation position of the first end effector—and therefore the first fastener—relative the strut channel; calculate a pre-installation path based on a known position and pose of the first end effector and the target installation location in the strut channel coordinate system; and trigger the end effector to maneuver along the calculated pre-installation path to locate the end effector at the target installation location of the strut channel.

Therefore, the robotic system can: trigger a first end effector to retrieve a first fastener from a first hopper at the robotic system; interpret a pre-installation location relative a strut channel proximal a fenestration within the building site; and autonomously locate the first end effector—and therefore the first fastener—at the target installation location for the strut channel in preparation for driving the first fastener toward the strut channel in order to couple the first fastener within the strut channel.

### 8.3.2.1 Examples: Initial Fastener Pose

In one example, the robotic system can: maneuver a first end effector to face a receptacle (e.g., a box) including a set of fasteners arranged proximal the robotic system; access an image from an optical sensor at the end effector defining a field of view of the set of the fasteners within the receptacle; as described above, implement computer vision techniques to interpret an initial fastener pose for a first fastener, in the set of fasteners, within the receptacle based on visual features extracted from the image; and trigger the first end effector to retrieve (e.g., grasp) the first fastener in the initial fastener pose from the receptacle. Accordingly, the robotic system can then: as described above, interpret the strut channel pose of the strut channel arranged at the local location of the facade bracket; and maneuver the first end effector to locate the first fastener over the strut channel based on the strut channel pose and the initial fastener pose of the first fastener retrieved from the receptacle. More specifically, the robotic system can: implement the transformation model to calculate a pre-installation path to locate the first fastener—in the initial fastener pose—at the target installation location in the strut channel coordinate system; and trigger the end effector to maneuver along the pre-installation path to locate the first fastener over the strut channel.

In another example, the robotic system can: trigger the first end effector to retrieve a first fastener, in a known fastener pose, from a hopper (e.g., vertical dispenser) containing a set of fasteners and arranged at the robotic system; and maneuver the first end effector to locate the first fastener over the strut channel based on the strut channel pose and the known fastener pose of the first fastener retrieved from the hopper. In this example, the hopper arranged at the robotic system is configured to consistently dispense the set of fasteners in an initial fastener pose, thereby eliminating the need for the robotic system to implement computer vision techniques to interpret the initial fastener pose during the fastener pre-installation process. Accordingly, the robotic system can: access an initial fastener pose corresponding to the fastener hopper arranged at the robotic system from internal memory; and execute closed loop controls to trigger the first end effector to grasp a first fastener from the fastener hopper—at the robotic system—in the initial fastener pose. Thus, the robotic system can then: implement the transformation model to calculate a pre-installation path to locate the first fastener—in the initial fastener pose—at the target installation location in the strut channel coordinate system; and trigger the end effector to maneuver along the pre-installation path to locate the first fastener over the strut channel.

### 8.3.3 End Effector Fastener Installation

Blocks of the Method S100 recite, in response to the strut channel pose corresponding to a target channel pose: triggering a first end effector, arranged on a first robotic arm at the robotic system, to retrieve a first fastener from a fastener hopper proximal the robotic system in Block S130; maneuvering the first end effector to locate the first fastener over the strut channel based on the strut channel pose in Block S132; and driving the first end effector toward the strut channel to locate the first fastener at a first lateral position along the strut channel in Block S134.

In one implementation, the robotic system can, upon locating the first fastener at the pre-installation location, drive the first end effector to couple the first fastener to the strut channel proximal the fenestration within the building site. In particular, the robotic system can execute a fastener installation cycle at the pre-installation location to: locate the first fastener within the strut channel; and lock the first fastener within the strut channel.

In one example, the robotic system can, at the target installation location, during performance of a fastener installation cycle: drive the first end effector toward the opening of the strut channel to locate the first within the strut channel; drive the first end effector to rotate the first fastener within the strut channel, thereby locking the first fastener within the strut channel; and drive the first end effector to locate the first fastener within a target lateral position within the strut channel based on the target installation location of the facade bracket.

In the aforementioned example, the robotic system can repeat steps described above in order to: trigger the first end effector to retrieve a second fastener from the first hopper at the robotic system; sweep the first end effector along a second pre-installation path to locate the first end effector—carrying the second fastener—to a second target installation location at the strut channel; and drive the first end effector to couple the second fastener within the strut channel at a lateral offset from the first fastener within the strut channel. Thus, the first fastener and the second fastener arranged within the strut channel are configured to receive a first bracket opening and a second bracket opening respectively of a facade bracket retrieved from a second hopper at the robotic system.

In one implementation, the robotic system can: interpret an installation error during execution of the fastener installation cycle based on a sequence of force values retrieved from the first end effector; and terminate execution of the fastener installation cycle responsive to interpreting the installation error based on the sequence of force values.

In one example, the robotic system can: access a sequence of force values output from the first end effector during driving of the first fastener within the strut channel; detect a constant force magnitude in the sequence of force values; interpret an edge collision for the first end effector (e.g., the first end effector missed the opening of the strut channel) responsive to a time duration of the constant force magnitude exceeding a threshold time duration; and terminate the fastener installation cycle responsive to interpreting the edge collision for the first end effector. The robotic system can subsequently implement blocks of the method S100 in order to: re-locate the first end effector at the pre-installation location for the strut channel; and trigger execution of the fastener installation cycle in order to again attempt to drive the first fastener within the strut channel.

In one implementation, the robotic system can, upon completion of the fastener installation cycle: confirm successful installation of the first fastener within the strut channel; and flag the target global location in the site map indicating successful fastener installation at the fenestration within the building site. In this implementation, the robotic system can: access a verification image captured by the camera at the first end effector depicting the first fastener arranged within the strut channel; extract a set of visual features from the verification image; and interpret successful installation of the first fastener within the strut channel responsive to the set of visual features from the verification image matching a target set of visual features corresponding to a target mounting pose of the first fastener relative the strut channel.

Alternatively, the robotic system can, responsive to the set of visual features from the verification image deviating from the target set of visual features, flag the fenestration in the site map for rework.

### 8.3.4 Dual Fastener Installation

In one implementation, the robotic system can: trigger the first robotic arm to locate the first end effector proximal the fastener hopper at the robotic system; trigger the first end effector to retrieve a second fastener from the fastener hopper; maneuver the first end effector to locate the second fastener over the strut channel based on the strut channel pose; and drive the first end effector toward the strut channel to locate the second fastener at a second lateral position, offset a first lateral position of the first fastener, along the strut channel. In this implementation, the first fastener is arranged at a target offset distance from the second fastener along the strut channel in order to receive apertures on the facade bracket during the bracket installation process. Accordingly, deviation from the target offset distance between the first fastener and the second fastener corresponds to a misalignment relative the apertures on the facade bracket and, thus results in a failure event during execution of the facade bracket installation, as described below. Thus, the robotic system can: following installation of the second fastener at the strut channel by the first end effector, access an image captured by an optical sensor defining a field of view of the first fastener and the second fastener installed at the strut channel; extract a set of visual features from the image; and implement computer vision techniques, as described above, to interpret an offset distance between the first fastener and the second fastener installed along the strut channel.

The robotic system can then: retrieve a target offset distance, such as from a fastener installation specification stored at the robotic system; and, in response to the offset distance exceeding a threshold deviation from the target offset distance, trigger the first end effector to apply a lateral force to the second fastener along the strut channel to locate the second fastener at a target lateral position from the first fastener along the strut channel in order to achieve the target offset distance. Additionally or alternatively, the robotic system can trigger the first end effector to apply a lateral force to the first fastener along the strut channel to locate the first fastener at a target lateral position from the second fastener to achieve the target offset distance. The robotic system can then: repeat the steps and processes described above to confirm the target offset distance between the first fastener and the second fastener along the strut channel; and, in response to confirming the offset distance, initiate a bracket installation cycle, as described below, to install the facade bracket at the local location.

### 8.3.5 Validating Fastener Installation

In one implementation, the robotic system can: following installation of the first fastener at the strut channel, access an image from an optical sensor at the first end effector defining a field of view of the local location including the installed fastener at the strut channel; and implement computer vision techniques, as described above, to validate installation of the first fastener at the strut channel. For example, the robotic system can: extract a set of visual features from a region in the image bounding the first fastener installed within the strut channel; interpret an installation fastener pose based on the set of visual features extracted from the region of the image; and, in response to the installation fastener pose corresponding to a target installation fastener pose, validate installation of the first fastener at the strut channel. Accordingly, in response to validating installation of the first fastener, the robotic system can initiate the bracket installation cycle, as described below, to install the facade bracket at the local location.

Alternatively, in response to the installation fastener pose exceeding a threshold deviation from the target installation pose, the robotic system can: interpret invalid installation of the first fastener at the strut channel; and flag the local location for fastener installation rework in a site map. Additionally, the robotic system can repeat the steps and techniques described above to repeat installation of the fastener at the strut channel.

In another implementation, the robotic system can: during installation of the first fastener at the strut channel, detect a sequence of force values from a force sensor coupled to the first end effector grasping the first fastener within the strut channel; and validate installation of the first fastener at the strut channel based on the sequence of force values. For example, the robotic system can: access a target sequence of force values representing successful installation of a fastener within a strut channel; and, in response to the sequence of force values matching the target sequence of force values, validate installation of the first fastener at the strut channel. In another example, the robotic system can: following installation of the first fastener within the strut channel, drive the first end effector—grasping the first fastener within the strut channel—to apply a target force opposite a ground plane including the strut channel; read a force value from the force sensor coupled to the first end effector during application of the fourth target force; and, in response to the force value exceeding a threshold force value, confirm engagement of a head of the first fastener with the strut channel at the local location and thus validate installation of the first fastener.

Accordingly, in response to validating installation of the first fastener, the robotic system can initiate the bracket installation cycle, as described below, to install the facade bracket at the local location. Additionally or alternatively, the robotic system can leverage a combination of the fastener installation pose and the sequence of force values to validate installation of the first fastener within the strut channel.

### 8.4 Bracket Installation

In one implementation, the robotic system can execute a bracket installation cycle at the target global location in order to install a facade bracket at the first fastener and the second fastener arranged within the strut channel. In particular, the robotic system can: detect a first pose of the first fastener within the strut channel; detect a second pose of the second fastener within the strut channel; sweep a second end effector—carrying a facade bracket retrieved from a second hopper at the robotic system—to a target installation location in alignment with the first fastener and the second fastener; and execute a bracket installation cycle to drive the facade bracket to couple the first fastener and the second fastener at the strut channel.

### 8.4.1 Fastener Pose Detection

Blocks of the method S100 recite: at a second time following the first time, accessing a second image from the optical sensor in Block S40, defining the field of view of the local location of the facade bracket; extracting a second set of visual features from a second region in the second image bounding the first fastener arranged within the strut channel in Block S142; and interpreting a fastener pose of the first fastener based on the second set of visual features from the second image in Block S144.

In one implementation, the robotic system can: access first image captured by the camera arranged at the second end effector of the robotic system defining a field of view intersection the installation of the facade bracket at the fenestration within the building site; and scan the second image for features of the first fastener and the second fastener arranged within the strut channel. In one example, the robotic system can: drive the second end effector to a target offset between the second end effector and the strut channel at the fenestration; trigger the camera to capture the second image depicting the strut channel including the first fastener and second fastener previously mounted; and extract a set of visual features (e.g., edges, blobs, surfaces) from the second image.

In this implementation, the robotic system can then: access a target fastener pose, such as from a installation specification document stored in memory of the robotic system; interpret a fastener pose (e.g., of the first fastener relative the second fastener) based on the visual features extracted from the second image; and, in response to the fastener pose corresponding to the target fastener pose, initiating a bracket installation cycle to couple a facade bracket to the first fastener and second fastener within the strut channel at the local location. More specifically, the robotic system can implement closed loop controls to retrieve a facade bracket from a hopper at the robotic system and install the facade bracket at the local location in the building site.

The robotic system can then implement heuristic techniques for the second image, such as random sampling and consensus on point cloud, edge detection, and/or surface reconstruction in order to detect presence of the first fastener and the second fastener within the strut channel in the second image. The robotic system can therefore, initiate a bracket installation cycle for the facade bracket at the fenestration in response to detecting presence of the first fastener and the second fastener within the strut channel.

### 8.4.2 Bracket Pre-Installation

In one implementation, the robotic system can: detect a first fastener pose for the first fastener arranged within the strut channel based on the visual features extracted from the second image; detect a second fastener pose for the second fastener arranged within the strut channel based on the visual features extracted from the second image; interpret a pre-installation location for the facade bracket at the first fastener and the second fastener based on the first fastener pose and the second fastener pose; and sweep the second end effector—gripping the facade bracket—along a pre-installation path to locate the second end effector at the pre-installation location over the strut channel in alignment with the first fastener and the second fastener.

In one example, the robotic system can: interpret a first fastener coordinate system based on the first fastener pose detected for the first fastener; project the first fastener coordinate system over the first fastener at the strut channel relative the building coordinate system within the building site; and interpret the pre-installation location for the facade bracket relative the first fastener according to the first fastener coordinate system. In particular the robotic system can: interpret a first axis (e.g., x-axis) for the first fastener according to a length of a drive recess of the first fastener defined in the first fastener pose; interpret a second axis (e.g., y-axis) for the first fastener perpendicular to the first axis according to a width of the drive recess of the first fastener; interpret a third axis (e.g., z-axis) for the first fastener normal to the first axis and the second axis representing a direction normal to a fastener plane; and interpolate the first axis, second axis, and the third axis to define the first fastener coordinate system. Additionally, the robotic system can: interpret a position of the vector based on features extracted from the second image; interpret a fastener vector (i.e., a vector parallel to a shaft of the fastener); and interpret the pre-installation location for the bracket based on the position and the fastener vector.

The robotic system can then: project a target installation location in the first fastener coordinate system representing the pre-installation position of the second end effector—and therefore the facade bracket—relative the first fastener; calculate a pre-installation path for the second end effector based on a known position and pose of the second end effector and the target installation location in the first fastener coordinate system; and trigger the second end effector to maneuver along the calculated pre-installation path to locate the second end effector at the target installation location of the first fastener, such as by aligning a first bracket opening of the facade bracket with the body of the first fastener.

Similarly, the robotic system can repeat the process described above in order to: interpret a second fastener coordinate system based on the second fastener pose detected for the second fastener; project the second fastener coordinate system over the second fastener at the strut channel relative the building coordinate system within the building site; and interpret the pre-installation location for the facade bracket relative the second fastener according to the second fastener coordinate system.

Therefore, the robotic system can: trigger the second robotic arm to locate a second end effector proximal a second hopper at the robotic system; trigger the second end effector to retrieve a facade bracket from the second hopper; interpret a pre-installation location relative the first fastener and the second fastener arranged within the strut channel proximal a fenestration within the building site; and autonomously locate the second end effector—and therefore the facade bracket—at the pre-installation location in preparation for driving the facade bracket toward the first fastener and the second fastener in order to couple the facade bracket at the fenestration within the building site.

### 8.4.2.1 Examples: Initial Bracket Pose

In one example, the robotic system can: following installation of the first fastener at the strut channel, maneuver the second end effector to face a receptacle (e.g., box) including a set of facade brackets arranged proximal the robotic system; access an image from the optical sensor at the second end effector defining a field of view of the set of facade brackets within the receptacle; implement computer vision techniques, as described above, to interpret an initial facade bracket pose for a first facade bracket, in the set of facade brackets, within the receptacle based on visual features extracted from the image; and trigger the second end effector to retrieve (e.g., grasp) the facade bracket in the initial facade bracket pose from the receptacle. Accordingly, the robotic system can then: as described above, interpret the first fastener pose of the first fastener installed within the strut channel at the local location; and maneuver the second end effector—grasping the facade bracket—to locate the facade bracket over the first fastener based on the first fastener pose and the initial facade bracket pose of the facade bracket retrieved from the receptacle. More specifically, the robotic system can: implement the transformation model to calculate a pre-installation path to locate a first aperture of the facade bracket—in the initial facade bracket pose—at the target installation location in the fastener coordinate system (i.e., in vertical alignment with the shank of the fastener); and trigger the second end effector to maneuver along the pre-installation path to locate the facade bracket over the first fastener at the strut channel.

In another example, the robotic system can: trigger a second robotic arm to locate a second end effector, coupled to the second robotic arm, proximal a hopper at the robotic system; trigger the second end effector to retrieve a facade bracket, in a known facade bracket pose, from the hopper (e.g., vertical dispenser) containing a set of facade brackets; and maneuver the second end effector to locate the facade bracket over the first fastener based on the first fastener pose and the known initial facade bracket pose of the facade bracket retrieved from the hopper. In this example, the hopper arranged at the robotic system is configured to consistently dispense the set of facade brackets in an initial facade bracket pose, thereby eliminating the need for the robotic system to implement computer vision techniques to interpret the initial facade bracket pose during the bracket pre-installation process. Accordingly, the robotic system can: access an initial facade bracket pose corresponding to the bracket hopper arranged at the robotic system from internal memory; and execute closed loop controls to trigger the second end effector to grasp a facade bracket from the bracket hopper—at the robotic system—in the initial facade bracket pose. Thus, the robotic system can then: implement the transformation model to calculate the pre-installation path to locate the facade bracket—in the initial facade bracket pose—at the target install location in the fastener coordinate system; and trigger the second end effector to maneuver along the pre-installation path to locate the facade bracket over the first fastener installed at the strut channel.

### 8.4.3 End Effector Bracket Installation

Blocks of the method S100 recite, in response to the fastener pose corresponding to a target fastener pose: triggering a second robotic arm at the robotic system to locate a second end effector, coupled to the second robotic arm, proximal a bracket hopper at the robotic system; triggering the second end effector to retrieve the facade bracket from a bracket hopper in Block S150; maneuvering the second end effector to locate a first aperture of the facade bracket over the first fastener at the strut channel based on the fastener pose in Block S152; and driving the second end effector toward the strut channel to couple the facade bracket to the first fastener at the strut channel in Block S154.

In one implementation, the robotic system can, upon locating the facade bracket at the pre-installation location, drive the second end effector to couple the facade bracket to the first fastener and the second fastener arranged within the strut channel proximal the fenestration within the building site.

In particular, the robotic system can execute a bracket installation cycle at the pre-installation location to mount the facade bracket to the first fastener and second fastener. For example, the robotic system can drive the second end effector—carrying the facade bracket—toward the first fastener and the second fastener thereby locating: the first fastener within a first bracket opening of the facade bracket; and the second fastener within a second bracket opening of the facade bracket.

In one implementation, the robotic system can: interpret an installation error during execution of the bracket installation cycle based on a second sequence of force values retrieved from the second end effector; and terminate execution of the bracket installation cycle responsive to interpreting the installation error. In this implementation, the robotic system can subsequently: re-locate the second end effector at the pre-installation location over the first fastener and the second fastener at the strut channel; and trigger execution of the bracket installation cycle in order to again attempt to couple the first fastener and the second fastener to the facade bracket.

In another implementation, the robotic system can, upon completion of the bracket installation cycle: access a verification image captured by the second camera at the second end effector upon completion of the bracket installation cycle; confirm successful installation of the facade bracket to the first fastener and the second fastener based on visual features extracted from the verification image; and flag the target global location in the site map indicating successful facade bracket installation at the fenestration within the building site.

### 8.4.4 Example: Two Fasteners+Bracket Installation

In one example, the robotic system can: access a first image from an optical sensor arranged at a robotic system proximal a fenestration in a building site and defining a field of view of a local location of a facade bracket of the fenestration; extract a set of visual features from the image depicting a strut channel at the local location; and, as described above, interpret a strut channel pose of the strut channel based on the set of visual features from the first image. The robotic system can then: trigger the first robotic arm to locate a first end effector proximal a fastener hopper at the touch sensor; trigger the first end effector to retrieve a first fastener from a fastener hopper; maneuver the first end effector—grasping the first fastener—to locate the first fastener over the strut channel based on the strut channel pose; and, as described above, drive the first end effector toward the strut channel to locate the first fastener at a first lateral position along the strut channel. Subsequently, the robotic system can: trigger the first robotic arm to locate a first end effector proximal the fastener hopper at the robotic system; trigger the first end effector to retrieve a second fastener from the fastener hopper; maneuver the first end effector—grasping the second fastener—to locate the second end effector over the strut channel based on the strut channel pose; and drive the first end effector toward the strut channel to locate the second fastener at a second lateral position, offset the first lateral position, along the strut channel.

Following installation of the first fastener and the second fastener at the strut channel, the robotic system can: access a second image from the optical sensor depicting the first fastener and the second fastener installed within the strut channel at the local location; extract a set of visual features from the second image; and, as described above, interpret a fastener pose of the first fastener relative the second fastener installed within the strut channel. More specifically, the robotic system can: interpret a lateral offset distance along the strut channel between the first fastener and the second fastener; interpret a first vertical axis of a first shank of the first fastener extending normal a ground plane of the strut channel; and interpret a second vertical axis of a second shank of the second fastener extending normal the ground plane of the strut channel.

Accordingly, the robotic system can then: trigger a second robotic arm to locate a second end effector proximal a bracket hopper at the robotic system; trigger the second end effector to retrieve a facade bracket from the bracket hopper; and maneuver the second end effector to locate 1) a first aperture of the facade bracket in alignment to the first vertical axis of the first shank of the first fastener and 2) a second aperture of the facade bracket in alignment to the second vertical axis of the second shank of the second fastener. The robotic system can then drive the second end effector toward the strut channel to couple the facade bracket to the first fastener and the second fastener at the strut channel and thus install the facade bracket at the local location.

### 8.4.5 Bracket Pose Validation

In one implementation, following coupling of the facade bracket to the first fastener at the strut channel, the robotic system can: access an image from the optical sensor depicting the facade bracket coupled to the first fastener at the strut channel; and implement computer vision techniques, as described above, to validate installation of the facade bracket at the strut channel. For example, the robotic system can: extract a set of visual features from a region in the image bounding the facade bracket installed at the strut channel; interpret an installation facade bracket pose based on the set of visual features extracted from the region of the image; and, in response to the installation facade bracket pose corresponding to a target installation pose, validate installation of the facade bracket at the strut channel. Accordingly, in response to validating installation of the facade bracket, the robotic system can initiate the washer installation cycle and/or nut installation cycle, as described below, to rigidly fix the facade bracket at the local location.

Alternatively, in response to the installation facade bracket pose exceeding a threshold deviation from the target installation pose, the robotic system can: interpret invalid installation of the facade bracket at the strut channel; and flag the local location including the facade bracket for installation rework in a site map.

### 8.5 Washer Installation

Blocks of the method S100 further recite maintaining the second end effector grasping the facade bracket coupled to the first fastener at the strut channel in Block S160. Blocks of the method S100 also recite: triggering the first robotic arm to locate the first end effector proximal a washer hopper at the robotic system; triggering the first end effector to retrieve a washer from the washer hopper in Block 170; maneuvering the first end effector to locate a second aperture of the washer over the first fastener at the strut channel based on the fastener pose in Block S172; and driving the first end effector toward the first fastener to couple the washer to the first fastener and the facade bracket in Block S174.

In one implementation, the robotic system can: trigger the second end effector to retrieve the facade bracket from the bracket hopper at the robotic system; maneuver the facade bracket over the first fastener based on the fastener pose; and trigger the second end effector to apply a target force toward the first fastener in order to couple the facade bracket to the first fastener, such as by inserting a shank of the fastener through an aperture of the facade bracket. Accordingly, following coupling of the facade bracket, the robotic system can: trigger the second end effector to maintain grasping of the facade bracket at the strut channel during a target time period; and initiate a washer installation cycle during the target time period, thereby maintaining the facade bracket in a target pose to avoid lateral movement of the facade bracket relative the strut channel during installation of the washer.

In this implementation, the robotic system can: trigger the second end effector to grasp the facade bracket coupled to the first fastener along the strut channel at the local location; trigger the first end effector to retrieve the washer, such as from a washer hopper (e.g., vertical dispenser) arranged at the robotic system; and maneuver the first end effector to locate the washer over the first fastener at the strut channel based on the fastener pose. More specifically, the robotic system can: align an aperture of the washer with a vertical axis of the shank of the first fastener extending from a ground plane, in the fastener coordinate system, including the strut channel; and drive the first end effector to apply a target force toward the ground plane thereby inserting the washer through the shank of the first fastener and coupling the washer to the facade bracket.

In one example, the facade bracket includes a top surface defining a set of serrations configured to mate with serrations arranged on a bottom surface of the washer. In this example, the robotic system can drive the washer toward the facade bracket in order to engage the serrated surface of the facade bracket with the serrated surface of the washer. In particular, the robotic system can drive the first end effector—grasping the washer—toward the facade bracket by: driving the first end effector to apply a target force toward the ground plane, including the strut channel, to couple the washer to the facade bracket; and driving the first end effector to apply a torque (or “perturbation”), in a first direction, about the washer to mate the serrated surface of the facade bracket with the serrated surface of the washer.

In one implementation, the robotic system can: during driving of the first end effector—grasping the washer—toward the first fastener and the facade bracket, read a sequence of force values from a force sensor coupled to the first end effector; and interpret successful engagement between the washer and the facade bracket (e.g., engagement of serrations between the washer and facade bracket) based on the sequence of force values. In particular, during application of the force (or “perturbation”) by the first end effector—grasping the washer—toward the facade bracket, the robotic system can: read a sequence of force values from the force sensor coupled to the first end effector; and, in response to a force value, in the sequence of force values, exceeding a threshold force value, interpret engagement of the serrated surface of the facade bracket to the serrated surface of the washer.

Alternatively, in response to a force value, in the sequence of force values, falling below a threshold force value, the robotic system can: interpret invalid engagement between the serrated surface of the facade bracket and the serrated surface of the washer; and flag the local location for washer installation rework in the site map. Additionally, the robotic system can repeat the steps and processes described above to re-attempt installation of the washer and/or install a second washer to a second fastener arranged at the strut channel.

In another implementation, the robotic system can: following coupling of the washer, access an image from the optical sensor depicting the washer coupled to the first fastener and the facade bracket at the strut channel; extract a set of visual features from the image; and, as described above, implement computer vision techniques to interpret a washer pose of the washer coupled to the first fastener and the facade bracket based on the set of visual features. Accordingly, the robotic system can then: validate installation of the washer in response to the washer pose corresponding to a target washer pose; and, in response to validating installation of the washer, initiate a nut installation cycle as described below to rigidly fix the facade bracket to the strut channel at the local location.

### 8.6 Nut Installation

Blocks of the method S100 further recite: triggering the first robotic arm to locate the first end effector proximal a nut hopper at the robotic system; triggering the first end effector to retrieve a nut from the nut hopper in Block S180; maneuvering the first end effector to locate a third aperture of the nut over the first fastener at the strut channel based on the fastener pose in Block S182; driving the first end effector toward the first fastener to couple the nut to the washer, the first fastener, and the facade bracket in Block S184; and driving the first end effector to apply a target torque on the nut along the first fastener to rigidly fix the facade bracket at the fenestration within the building site.

In one implementation, following the washer installation cycle, the robotic system can: trigger the second end effector to grasp the facade bracket coupled to the first fastener along the strut channel at the local location; trigger the first end effector to retrieve a nut, such as from a nut hopper (e.g., vertical dispenser) arranged at the robotic system; and maneuver the first end effector to locate the nut over the first fastener—coupled to the washer and the facade bracket—at the strut channel based on the first pose. More specifically, the robotic system can: align an aperture of the nut with a vertical axis of the shank of the first fastener extending from a ground plane, in the fastener coordinate system, including the strut channel; and drive the first end effector to apply a target force toward the ground plane, thereby inserting the nut through the shank of the first fastener.

In this implementation, prior to driving the nut to engage threading across the shank of the first fastener to rigidly fix the facade bracket to the strut channel, the robotic system can: validate an installation pose of the facade bracket, the first fastener, the washer, and the nut at the strut channel; and, in response to validating the installation pose, trigger the first end effector to apply a target torque to the nut in order to engage threading of the first fastener and thus rigidly fix the facade bracket to the strut channel in the installation pose.

Alternatively, in response to detecting an invalid installation pose, the robotic system can trigger the second end effector to apply a lateral force along the strut channel in order to locate the facade bracket—and therefore the first fastener, the washer, and the nut—in the target installation pose. More specifically, the robotic system can: following coupling of the nut to the shank of the first fastener, access an image from the optical sensor depicting the facade bracket, the first fastener, the washer, and the nut at the strut channel; extract a set of visual features from the image; and, as described above, implement computer vision techniques to interpret an installation pose of the facade bracket—coupled to the first fastener, the washer, and the nut—based on the set of visual features. Accordingly, in response to the installation pose exceeding a threshold deviation from a target installation pose, the robotic system can: trigger the second end effector—grasping the facade bracket—to apply a lateral force along the strut channel to locate the facade bracket in the target installation pose; and drive the first end effector to apply a torque to the nut in order to engage threading of the first fastener, thereby coupling the nut to the washer, the facade bracket, and the first fastener at the strut channel.

Therefore, the robotic system can: locate the facade bracket—coupled to the first fastener, the washer, and the nut—in a target installation pose along the strut channel; and drive the first end effector grasping the nut to rigidly couple the facade bracket in the target installation pose to the strut channel at the local location, thereby enabling subsequent installation of a facade at the fenestration within the building site.

### 8.7 Bracket Install Validation

In one implementation, the robotic system can, following the nut installation cycle, validate rigid coupling for the facade bracket to the strut channel at the local location. In this implementation, the robotic system can: following driving of the first end effector to apply a torque to the nut, trigger the second end effector to grasp the facade bracket at the strut channel; drive the second end effector to apply a target force opposite a ground plane including the strut channel; and read a sequence of force values from a force sensor coupled to the second end effector during application of the target force. Accordingly, the robotic system can then validate installation of the facade bracket to the strut channel based on the sequence of force values.

More specifically, the robotic system can: in response to a force value, in the sequence of force values, exceeding a threshold force value, validate installation of the facade bracket to the strut channel; and maneuver the robotic system to a second local location—extracted from the site map—for installation of a second facade bracket at the building site. Alternatively, in response to the sequence of force values deviating from a target sequence of force values, the robotic system can: detect wobbly engagement of the facade bracket to the strut channel; and interpret invalid installation of the facade bracket. Therefore, the robotic system can: flag the local location for installation rework within a site map; and transfer the site map to a local operator for manual rework of the facade bracket installation at the local location.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for autonomously installing facade brackets within a building site comprising:
at a first time, accessing a first image from an optical sensor arranged at a robotic system proximal a fenestration at the building site and defining a field of view of a local location of a facade bracket of the fenestration;
extracting a first set of visual features from a first region in the first image bounding a strut channel at the local location of the facade bracket;
interpreting a strut channel pose of the strut channel based on the first set of visual features from the first image;
in response to the strut channel pose corresponding to a target channel pose:
triggering a first robotic arm at the robotic system to locate a first end effector, coupled to the first robotic arm, proximal a fastener hopper at the robotic system;
triggering the first end effector to retrieve a first fastener from the fastener hopper;
maneuvering the first end effector to locate the first fastener over the strut channel based on the strut channel pose; and
driving the first end effector toward the strut channel to locate the first fastener at a first lateral position along the strut channel;
at a second time following the first time, accessing a second image from the optical sensor defining the field of view of the local location of the facade bracket;
extracting a second set of visual features from a second region in the second image bounding the first fastener arranged within the strut channel;
interpreting a fastener pose of the first fastener based on the second set of visual features from the second image; and
in response to the fastener pose corresponding to a target fastener pose:
triggering a second robotic arm at the robotic system to locate a second end effector, coupled to the second robotic arm, proximal a bracket hopper at the robotic system;
triggering the second end effector to retrieve a facade bracket from the bracket hopper;
maneuvering the second end effector to locate a first aperture of the facade bracket over the first fastener at the strut channel based on the fastener pose; and
driving the second end effector toward the strut channel to couple the facade bracket to the first fastener at the strut channel.

2. The method of claim 1:
further comprising, in response to the strut channel pose corresponding to the target channel pose:
triggering the first robotic arm to locate the first end effector proximal the fastener hopper;
triggering the first end effector to retrieve a second fastener from the fastener hopper;
maneuvering the first end effector to locate the second fastener over the strut channel based on the strut channel pose; and
driving the first end effector toward the strut channel to locate the second fastener at a second lateral position, offset the first lateral position, along the strut channel;
wherein extracting the second set of visual features comprises extracting the second set of visual features from the second region in the second image bounding the first fastener and the second fastener arranged within the strut channel;
wherein interpreting the fastener pose comprises interpreting the fastener pose of the first fastener relative the second fastener within the strut channel based on the second set of visual features;
wherein maneuvering the second end effector comprises, based on the fastener pose, maneuvering the second end effector to locate the first aperture of the facade bracket over the first fastener and a second aperture of the facade bracket over the second fastener; and
wherein driving the second end effector toward the strut channel comprises driving the second end effector toward the strut channel to couple the facade bracket to the first fastener and the second fastener at the strut channel.

3. The method of claim 2, wherein interpreting the fastener pose of the first fastener relative the second fastener comprises:
interpreting an offset distance between the first fastener and the second fastener within the strut channel; and
in response to the offset distance deviating from a target offset distance, driving the first end effector to locate the second fastener at a target lateral position along the strut channel according to the target offset distance.

4. The method of claim 1, wherein driving the first end effector, grasping the first fastener, toward the strut channel comprises:
driving the first end effector to apply a target force toward the strut channel to locate the first fastener within the strut channel;
driving the first end effector to rotate the first fastener within the strut channel to anchor a head of the first fastener within the strut channel; and
driving the first end effector to locate the first fastener at a target lateral position along the strut channel based on the local location of the facade bracket, the first fastener comprising a shank extending from the target lateral position on the strut channel.

5. The method of claim 1:
wherein driving the first end effector, grasping the first fastener, toward the strut channel comprises, driving the first end effector to apply a target force toward the strut channel to engage a head of the first fastener within the strut channel; and
further comprising:
reading a sequence of force values from a force sensor coupled to the end effector during driving of the first end effector to locate the first fastener within the strut channel; and
in response to detecting engagement of the head of the first fastener within the strut channel based on the sequence of force values, triggering the second end effector to retrieve the facade bracket from the bracket hopper.

6. The method of claim 1, further comprising:
maintaining the second end effector grasping the facade bracket coupled to the first fastener at the strut channel;
during a third time period following the second time:
triggering the first robotic arm to locate the first end effector proximal a washer hopper at the robotic system;
triggering the first end effector to retrieve a washer from the washer hopper;
maneuvering the first end effector to locate a second aperture of the washer over the first fastener at the strut channel based on the fastener pose; and
driving the first end effector toward the first fastener to couple the washer to the first fastener and the facade bracket; and
during a fourth time period following the third time period:
triggering the first rotor assembly to locate the first end effector proximal a nut hopper at the robotic system;
triggering the first end effector to retrieve a nut from the nut hopper;
maneuvering the first end effector to locate a third aperture of the nut over the first fastener at the strut channel based on the fastener pose;
driving the first end effector toward the first fastener to couple the nut to the washer, the first fastener, and the facade bracket; and
driving the first end effector to apply a target torque on the nut along the first fastener to rigidly fix the facade bracket at the fenestration within the building site.

7. The method of claim 6:
further comprising, during the fourth time period:
accessing a third image from the optical sensor arranged at the robotic system and defining the field of view of the local location;
extracting a third set of visual features from a third region in the third image bounding the first fastener, the facade bracket, the washer, and the nut coupled to the strut channel at the local location; and
interpreting a facade bracket pose along the strut channel based on the third set of visual features from the third image; and
wherein driving the first end effector to apply the target torque on the nut along the first fastener comprises:
in response to the facade bracket pose deviating from a target bracket pose, maneuvering the second end effector, grasping the facade bracket, to laterally locate the facade bracket along the strut channel according to the target facade bracket pose; and
driving the end effector to apply the target torque on the nut along the first fastener to rigidly fix the facade bracket, in the target facade bracket pose along the strut channel, at the fenestration within the building site.

8. The method of claim 6:
wherein driving the first end effector toward the first fastener to couple the washer to the first fastener and the facade bracket comprises:
driving the first end effector to apply a target force toward strut channel to couple the washer to the facade bracket, the washer comprising a first serrated surface abutting with a second serrated surface of the facade bracket; and
driving the first end effector to apply a torque, in a first direction, about the washer to mate the first serrated surface with the second serrated surface; and
further comprising:
detecting a sequence of force values from a force sensor coupled to the end effector during driving the first end effector toward the first fastener; and
in response to detecting engagement of the first serrated surface to the second serrated surface based on the sequence of force values, triggering the first end effector to retrieve the nut from a nut hopper proximal the robotic system.

9. The method of claim 6, further comprising during the fourth time period:
driving the second end effector, grasping the facade bracket, to apply a target force normal a ground plane comprising the strut channel;
reading a sequence of force values from a force sensor coupled to the second end effector during driving of the second end effector; and
in response to detecting wobbly engagement of the facade bracket to the strut channel based on the sequence of force values, driving the first end effector to apply the target torque on the nut along the first fastener to rigidly fix the facade bracket to the strut channel.

10. The method of claim 1:
at a third time, maneuvering the robotic system proximal a second local location of the facade bracket of a second fenestration within the building site;
accessing a third image from the optical sensor defining a field of view of the second local location of the facade bracket;
scanning the third image for visual features of the strut channel; and
in response to detecting absence of features of the strut channel in the third image, flagging the second fenestration for strut channel rework in a site map representing the building site.

11. The method of claim 1:
wherein triggering the first end effector to retrieve the first fastener comprises triggering the first end effector to retrieve the first fastener from the fastener hopper in an initial fastener pose;
wherein interpreting the strut channel pose of the strut channel comprises:
based on the first set of visual features:
interpreting a first axis for the strut channel representing a length of a strut channel opening;
interpreting a second axis, orthogonal the first axis, for the strut channel representing a width of the strut channel opening; and
interpreting a third axis for the strut channel representing a direction normal to a ground plane; and
interpolating the first axis, second axis, and third axis to define a strut channel coordinate system for the strut channel; and
wherein maneuvering the first end effector to locate the first fastener over the strut channel comprises:
projecting a target position in the strut channel coordinate system representing a pre-installation location of the first end effector relative the strut channel at the local location;
calculating a path for maneuvering the first end effector based on the initial fastener pose and the target position;
triggering the first end effector to maneuver along the path to locate the first end effector, grasping the first fastener, at the target position; and
in response to locating the first end effector at the target position, driving the first end effector to install the first fastener at the strut channel.

12. The method of claim 1:
wherein triggering the second end effector to retrieve the facade bracket comprises triggering the second end effector to retrieve the facade bracket from the bracket hopper in an initial facade bracket pose;
wherein interpreting the first fastener pose of the first fastener comprises:
based on the second set of visual features:
interpreting a first axis for the first fastener representing a length of a drive recess of the first fastener;
interpreting a second axis, orthogonal the first axis, for the first fastener representing a width of the drive recess of the first fastener; and
interpreting a third axis for the first fastener representing a direction normal to a ground plane; and
interpolating the first axis, the second axis, and the third axis to define a first fastener coordinate system for the first fastener; and
wherein maneuvering the second end effector to locate the first aperture of the facade bracket over the first fastener comprises:
projecting a target position in the first fastener coordinate system representing a pre-installation location of the second end effector relative the first fastener within the strut channel;
calculating a path for maneuver the second end effector based on the initial facade bracket pose and the target position;
triggering the second end effector to maneuver along the path to locate the second end effector, grasping the facade bracket, to the target position; and
in response to locating the second end effector at the target position, driving the second end effector to install the facade bracket at the strut channel.

13. The method of claim 1:
wherein accessing the first image comprises accessing the first image defining a field of view of the local location of the facade bracket across a ground plane of a building structure within the building site; and
further comprising:
maneuvering the robotic system proximal a second local location of a second fenestration at the building site;
accessing a third image defining a field of view of the second local location of the facade bracket across a perimeter plane, orthogonal the ground plane, of the building structure;
scanning the third image for features of the strut channel; and
in response to detecting features of the strut channel in the third image, triggering the first end effector to retrieve a second fastener from the fastener hopper for installation within the strut channel across the perimeter plane of the building structure.

14. The method of claim 1, further comprising:
at an initial time prior to the first time, accessing a site map representing the building site;
sweeping the first end effector on the first robotic arm through a first sequence of poses defined within a robotic coordinate system;
accessing a first sequence of reference positions of the first end effector within a reference coordinate system from a survey sensor arranged within the building site proximal the robotic system;
interpreting a transformation model between poses of the first end effector and a building coordinate system, defined in the site map, based on:
the first sequence of poses;
the first sequence of reference positions; and
a first position of the survey sensor within the building site;
extracting a target global location of the facade bracket, in the building coordinate system, from the site map;
transforming the target global location of the facade bracket in the building coordinate system into a local location of the facade bracket in the robotic coordinate system based on the transformation model; and
maneuvering the robotic system proximal the local location of the facade bracket within the building site.

15. The method of claim 1:
wherein triggering the first end effector to retrieve the first fastener from the fastener hopper comprises:
accessing a third image from a second optical sensor arranged at the first end effector and defining a field of view of the first end effector grasping the first fastener;
extracting a third set of visual features from the third image; and
interpreting an initial pose of the first fastener at the first end effector based on the third set of visual features; and
wherein maneuvering the first end effector to locate the first fastener over the strut channel comprises maneuvering the first end effector to locate the first fastener over the strut channel based on the strut channel pose and the initial fastener pose.

16. A method for autonomously installing facade brackets within a building site comprising, at a robotic system:
during a fastener installation period:
accessing a first image from an optical sensor defining a field of view of a local location of a facade bracket for a fenestration within the building site;
extracting a first set of visual features from the first image depicting a strut channel at the local location of the facade bracket;
interpreting a strut channel pose of the strut channel based on the first set of visual features;
triggering a robotic arm at a robotic system to locate an end effector, coupled to the robotic arm, proximal a set of fasteners at the local location;
triggering the end effector to retrieve a first fastener from the set of fasteners;
maneuvering the end effector to locate the first fastener over the strut channel based on the strut channel pose; and
driving the end effector toward the strut channel to locate the first fastener at a first lateral position within the strut channel; and
during a bracket installation period:
accessing a second image from the optical sensor defining the field of view of the local location of the facade bracket;
extracting a second set of visual features from the second image depicting the first fastener coupled to the strut channel;
interpreting a fastener pose of the first fastener based on the second set of visual features;
triggering the robotic arm to locate the end effector proximal a set of brackets at the local location;
triggering the end effector to retrieve a facade bracket from the set of brackets;
maneuvering the end effector to locate the facade bracket over the first fastener at the strut channel based on the fastener pose; and
driving the end effector toward the strut channel to couple the facade bracket to the first fastener at the strut channel.

17. The method of claim 16:
further comprising, during the fastener installation period:
triggering the robotic arm to locate the end effector proximal the set of fasteners;
triggering the end effector to retrieve a second fastener from the set of fasteners;
maneuvering the end effector to locate the second fastener over the strut channel based on the strut channel pose; and
driving the end effector toward the strut channel to locate the second fastener at a second lateral position, offset the first lateral position, along the strut channel; and
wherein interpreting the fastener pose comprises:
interpreting an offset distance between the first fastener and the second fastener within the strut channel based on the second set of visual features; and
in response to the offset distance deviating from a target offset distance, driving the end effector to locate the second fastener at a target lateral position along the strut channel according to the target offset distance.

18. The method of claim 17:
wherein maneuvering the end effector to locate the facade bracket comprises maneuvering the end effector to locate a first aperture of the facade bracket over the first fastener and a second aperture of the facade bracket over the second fastener; and
wherein driving the end effector, grasping the facade bracket, toward the strut channel comprises driving the end effector toward the strut channel to couple the facade bracket to the first fastener and the second fastener at the strut channel.

19. The method of claim 16, further comprising:
maintaining the end effector grasping the facade bracket coupled to the first fastener at the strut channel;
during a washer installation period:
triggering a second robotic arm at the robotic system to locate a second end effector, coupled to the second robotic arm, proximal a set of washers at the local location;
triggering the second end effector to retrieve a washer from the set of washers;
maneuvering the second end effector to locate the washer over the first fastener at the strut channel based on the fastener pose; and
driving the second end effector toward the first fastener to couple the washer to the first fastener and the facade bracket; and
during a nut installation period:
triggering the second robotic arm to locate the second end effector proximal a set of nuts at the local location;
triggering the second end effector to retrieve a nut from the set of nuts;
maneuvering the second end effector to locate the nut over the first fastener at the strut channel based on the fastener pose; and
driving the second end effector toward the first fastener to couple the nut to the first fastener, the washer, and the facade bracket.

20. A method for autonomously installing facade brackets within a building site comprising:
triggering a robotic arm to locate an end effector, coupled to the robotic arm, proximal a set of fasteners at a local location of a facade bracket within the building site;
triggering the end effector to retrieve a fastener from the set of fasteners;
accessing a first image from an optical sensor arranged at the end effector and defining a field of view of the local location;
scanning the first image for features of a strut channel;
in response to detecting features of the strut channel in the first image:
maneuvering the end effector to locate the fastener over the strut channel based on the strut channel pose; and
driving the end effector toward the strut channel to locate the fastener at a first lateral position within the strut channel;
triggering the robotic arm to locate the end effector proximal a set of brackets at the local location;
triggering the end effector to retrieve a facade bracket from the set of brackets;
accessing a second image from the optical sensor defining the field of view of the local location of the facade bracket;
scanning the second image for features of the fastener; and
in response to detecting features of the fastener:
maneuvering the end effector to locate the facade bracket over the fastener at the strut channel based on the fastener pose; and
driving the end effector toward the strut channel to couple the facade bracket to the fastener at the strut channel.
